(19) United States
(12) Patent Application Publication
(10) Pub. No.: US 2009/0023119 A1
(43) Pub. Date: Jan. 22, 2009

(54) Method for learning a foreign language

(76) Inventor: Samuel Gordon Breidner, Little River, SC (US)

Correspondence Address: P. Jeff Martin of The McGougan Law Firm, LLC, 1180 Hwy. 17 N., Suite 2, P.O. Box 250, Little River, SC, 29566, US

(21) Appl. No.: 11/879,349

(22) Filed: Jul. 17, 2007

(51) Int. Cl. G09B 19/06

(52) U.S. Cl. 434/157

(57) ABSTRACT

A method for learning a foreign language using a learning aid is provided. The learning aid includes a reading manual having a plurality of pages organized into a number of sections which are read in an orderly fashion in order to facilitate incremental advancement and masterfulness concerning the learning of a target language. The method involves building an active foreign language alphabet and language as it is done naturally in user's native language.

### RELATED APPLICATIONS

There are no previously filed, nor currently any co-pending applications, anywhere in the world.

### BACKGROUND OF THE INVENTION

1. Field of the Invention

The present invention relates generally to foreign language learning methods and, more particularly, to a method for learning a foreign language using a learning aid.

2. Description of the Related Art

Any program of learning by its very nature requires teaching, either by one's experience or by formal instruction. The process of teaching follows an interaction with anything that exists, and learning a relationship thereto.

To know or to discover and to identify anything that exists creates cognition, which is the act of knowing or identifying. Cognition may be called perception, according to each individuals' mode of learning (their modality). The task-oriented result is education.

A modification of individual behavior is education. It does not matter whether an individual is learning to tie shoelaces, to housebreak a dog, to resolve complex mathematical equations, or to develop a marketing campaign for canned chicken soup, education occurs when prior learning enables the modification to be achieved. However, achievement is based upon the elements of education functioning within two concepts, intelligence and/or intellect.

All humans exhibit intelligence, which may be defined as memory or recall. It is through experience that individuals proceed from conscious memory or recall to an imprinted action that requires no conscious effort. The experience of learning how to tie shoelaces or open or close a water faucet initially requires conscious memory/recall, but after repetitive actions a modification of behavior takes place and a stimulus to an individual will create a rote response, called imprinting. This basic element of education makes it possible for an individual to touch, type, play a piano, drive a car, or to read, write, and speak words that transmit thoughts.

All humans exhibit intellect in varying degrees, which is the ability to understand relationships. Intellect is the ability to take elements of intelligence and understand their relationship in order to produce reason, as an outcome of learning. This element of education is evidenced by a modification of behavior that may be called understanding or comprehension, and permits the individual to solve highly complex problems.

Everyone uses convergent thinking in order to do daily tasks, whether making breakfast, dressing, or going to the supermarket, intelligence permits routines to easily be accomplished. Repetitive tasks are more easily accomplished through convergent thinking operations. The degree to which individuals are convergent in their thinking is generally environmentally generated. Convergent thinkers tend to be very literal in their understandings of concepts, and especially new concepts. They tend to associate themselves with rigid and unyielding attitudes and policies regarding nation, political party, culture, organization, or a belief system in which they have been imprinted. The degree to which this behavioral mode impacts their education is a function of an individual's behavior modification. For convergent thinkers, utilizing a high-interest level material, which delivers immediate gratification where such material is transmitted through imprinting in one's native tongue and transmuted to a target language, can be a major driving force concerning motivation for implementing a method for learning a foreign language. Convergent thinkers rely heavily upon their intelligence (memory/recall). To the convergent thinker, a brick may be used to build a house, build a fireplace, construct a brick walkway, or to build a wall.

Environment plays a major role in creating divergent thinking skills. The ability to consider divergent understandings of learning anything is called intellect. Knowing or identifying anything is cognition, and once it is registered in the individual's memory, it may be re-cognated or recognized. Combinations of previously learned material are brought together by the divergent thinker in order to provide reasoned understandings of new concepts. These new concepts come together in a confluent amalgam to produce education, a new understanding that has modified the individual's behavior. Divergent thinkers rely heavily upon their intellect, the ability to see relationships. To the divergent thinker, a brick may be ground into red powder and mixed with plaster in order to make a relief map of the Rocky Mountains. Two bricks may be placed in a lavatory's reservoir to reduce water consumption. The inside of a brick may be hollowed and filled with jewelry for placement in a brick wall to hinder burglars.

Learning is completely dependent upon the individual's modalities during the act of cognition. A brief examination of some of the modalities of learning, and its impact upon the modification of the learner's behavior is imperative if education is to take place. Convergent and divergent thinking operations are performed by individuals using their favorite combination of methods for solving problems, because their experience has shown them that the mindset of methods they are using to think has been the most productive manner to learn anything they consider. Those methods of solving problems are called modalities.

Auditory discrimination is vital if the individual is to pursue language in a meaningful way. Primary to the effective use of a method for learning a foreign language, an understanding of the sounds of printed letters as they are blended together into a word which is identifiable as a component of an idea. This concept is referred to as codex. English language learners follow a phonetic approach, which is based on convergent thinking. These learners quickly move from decoding letters into sound, to whole word recognition in order to form word clusters that can be said togetherwith lucidity. In the Anglo-Saxon language, sounds of the word are often different than the sounds in the word. The word “sugar” is not “soogar”. The visual discrimination of gum/gun, when expressed in the context of a sentence, is often difficult if auditory discrimination has not be properly dealt with, as auditory discrimination proceeds visual discrimination in human development. For example, “He took the gum/gun in his hand,” requires the use of divergent thinking abilities as the reader adjusts the literal decoding of the word as perceived and discriminates its meaning as evidence by the word's proper pronunciation because the reader is aware of the sense of the sentence. For example, “You can open the can.” This visual discrimination follows perceptions/cognition and is completely dependent upon auditory discrimination.

The ability to read a map, follow a blueprint, understand a design, navigate a course, and conceive geometric concepts is the result of a schematic modality which has very important implications for learning. Many people have learned to read using flash cards which enable individuals to wee whole words that they might have difficulty spelling, such as Lieutenant, cafeteria, Mississippi, and boulevard. However, these words are readily understood in the context of a sentence thanks to schematic ability on the part of the reader. Schematic thinking occurs when the imprinting of the word's design is established in a convergent inventory of knowledge and it is this cognition that permits recognition of a word that represent identifiable thought. A common example is the Coca-Cola® logo.

Language learning for individuals with a strong figural modality can be strengthened using imprinting as an outcome of convergent thinking. The symbiotic relationship of mathematics to musical ability, which is often used in the playing of an instrument with both hands, requires the functional understanding of an equation. The popularity of Dr. Seuss's basic use of poetical music in a series of children's books to young children, below the age of puberty, when a better understanding of relationships provokes intellectual thinking, gives testimony to the subliminal use of the music in our language and its importance in imprinting whole words, word clusters, and/r a codex in an individual's inventory of knowledge as a result of convergent thinking operations. Childish jingles, advertising slogans, popular tunes, the Psalms, and worship liturgics are understood and retained through the modality of figural thinking operations.

It is most often thought that there is a symbiotic relationship between age and maturity, and that is the reason children and adolescents tend to have a short attention span. That concept is false. Children and adolescents can absorb themselves in a video game or an age appropriate television show for hours at a time. Adults, at any age, evidence a very short attention span except for one intervening variable, their apperceptive base. Apperception is the ability to perceive clearly, to observe, to recognize and to have full understanding of the assimilation of new information as a result of convergent thinking (memory/recall) operations provoking the individual's inventory of knowledge, which may produce, in the case of a divergent thinker, intellectual outcomes. An expanded attention span fuels the desire not to leave in the middle of a movie, television show, interesting book or other sedentary intellectual involvement. An expanded attention span is often identified as motivation. It relies heavily upon an apperceptive base which motivates the individual's desire for an outcome concerning the current task-oriented activity. That outcome has been projected by the individual's prior inventory of knowledge. The motivating result is satisfaction, because the individual projected the end of the movie, the television show, the interesting book, or other activity. A method for learning a foreign language must provide high interest level, age-appropriate material, synchronized with a program which provides audio and visual discrimination and its concomitant delivery of a phoneme inventory to the learner.

In teaching a foreign language, many traditional methods have been utilized such as the translation method, the audio-lingual method, the direct method, and the total immersion method. These methods utilize memorization, grammar, repetition, speaking and listening, communication exchange, learning aids, and audio-visual media. However, the aforementioned conventional methods have been unsuccessful in providing a method by which a foreign language can be learned quickly, easily, and efficiently.

Accordingly, there is a widely recognized need for a method by which a foreign language can be learned by building an active foreign language alphabet in a natural way as it is done in user's native language in a manner which is quick, easy, and efficient. The development of the method for learning a foreign language fulfills this need.

A search of the prior art did not disclose any patents that read directly on the claims of the instant invention; however, the following references were considered related:

U.S. Pat. No. 6,325,630 B1, issued in the name of Grabmayr;

U.S. Pat. No. 4,734,036, issued in the name of Kasha;

U.S. Pat. No. 5,735,693, issued in the name of Groiss;

U.S. Pat. No. 5,810,598, issued in the name of Wakamoto;

U.S. Pat. No. 6,341,958 B1, issued in the name of Zilberman;

U.S. Pat. No. 6,409,510 B1, issued in the name of Firebaugh;

U.S. Pat. No. 6,736,641 B2, issued in the name of Quiroz; and

U.S. Pat. No. 5,215,466, issued in the name of Rubio.

Consequently, a need has been felt for an improved method for learning a foreign language in a manner which is quick, easy, and efficient.

### SUMMARY OF THE INVENTION

Therefore, it is an object of the present invention to provide a method by which a foreign language can be learned in a manner which is quick, easy, and efficient.

It is another object of the present invention to provide a method by which a foreign language can be learned by building an active foreign language alphabet and language in a natural way as it is done in user's native language.

It is another object of the present invention to teach users to read first and allow speech to follow.

It is another object of the present invention to provide a learning aid which includes a reading book having a plurality of pages organized into a plurality of sections which are read in an orderly fashion in order to facilitate incremental advancement and masterfulness concerning the learning of a desired foreign language.

It is another object of the present invention to provide a plurality of sections having a first section, a second section, and a plurality of supplemental sections.

It is another object of the present invention to provide first, second, and supplemental sections which are structured in a manner so as to allow the user of the method to quickly understand that specific target letters represent specific source letters.

It is still another object of the present invention to replace native words provided in the first, second, and supplemental sections with target language words being in proper syntax structure.

It is another object of the present invention to group target language words into meaningful word clusters in order to facilitate comprehension.

It is yet another object of the present invention to motivate the student through apperception by providing motion picture videos with closed captioning, thereby facilitating greater success in learning a foreign language.

Briefly described according to one embodiment of the present invention, a method for learning a foreign language using a learning aid is disclosed. The learning aid comprises a reading book or manual having a plurality of pages or sheets organized into a plurality of sections which are read in an orderly fashion in order to facilitate incremental advancement and masterfulness concerning the learning of a target language or desired foreign language.

The plurality of sections comprises a first section comprised of at least one sentence printed with source terms, wherein source terms are defined as individual terms printed in user's native language. The source terms are comprised of source letters, symbols, and/or characters.

Below the at least one sentence of source terms, at least one first replacement sentence is provided. The replacement sentence comprises the at least one sentence, but having each occurrence of a specific single source letter, which appears in each term of the at least one sentence, replaced by a first target letter. The first target letter is a transliteration of the specific single source letter.

The present invention allows the user to progress in the building of an active foreign language alphabet in a natural way as it is done in user's native language.

Printed directly below the first replacement sentence(s), an at least one first supplemental sentence is provided, wherein the at least one first supplemental sentence comprises source terms having the single source letter replaced by the first target letter.

The first section is structured in a manner so as to allow the user of the method to quickly understand that the first target letter represents a specific source letter. Replacement of a specific source letter with a specific target letter also facilitates instantaneous recall concerning the source letter/target letter replacement relationship. To enhance this understanding, a plurality of first supplemental sentences may be printed in the first section, wherein first supplemental sentences are separate from each other and arranged adjacently and vertically.

The first section further comprises a first application section following the at least one first supplemental sentences, wherein the application section comprises a plurality of writings in the form of rhymes, poetry, short stories and other literary works, historical documents and the like, and including excerpts therefrom, comprised of prominent compositions. The writings each comprise a number of sentences which include source terms each having all occurrences of the source letter thereof replaced by the first target letter. The source letter corresponds to the same source letter as denoted heretofore in the first section, and the first target letter corresponds to the same first target letter denoted in the first section.

The writings may comprise an excerpt and/or passage, and/or a complete writing or complete literary composition such as Casey At The Bat, by Ernest L. Thayer, wherein the source terms therein each having all occurrences of the source letter thereof replaced by the first target letter.

The first section includes a first unit section following the first application section, wherein first unit section comprises a vertical list of short phrases or sentences printed with source terms, denoted as column “A”, but having the source letter replaced by the first target letter. Adjacent to column “A”, an additional vertical list of short phrases or sentences is provided and denoted as column “B”, wherein the phrases are identical in number with respect to phrases or sentences imprinted in column “A” and are horizontally aligned therewith so as to form a corresponding number of rows of text. The short phrases provided in column “B” comprise the target language translations of the sentences provided in column “A”. The short phrases provided in column “B” are written so as to follow the syntax structure of the target language. More specifically, the phrases provided in each row under column “B” provide the translations which are written either from left to right or from right to left for each phrase in corresponding adjacent rows. The use of column “B” introduces the user to the proper syntax structure and proper transmutative form concerning the target language. The transmutative form is the literal translation of the native language to the target language, and such form may be a contracted or an expanded writing in comparison to the language being translated, particularly where one language is character-based.

The plurality of sections includes a second section following the first unit section. The second section is comprised of at least one sentence printed with source terms. Below the at least one sentence of source terms, at least one second replacement sentence is provided. The second replacement sentence comprises the at least one sentence, shown printed directly thereabove, but having each occurrence of the first source letter replaced by the first target letter as described in the first section, and having each occurrence of a second source letter replaced by a second target letter.

Printed directly below the second replacement sentence(s), an at least one second supplemental sentence is provided, wherein the at least one second supplemental sentence comprises source terms having the first source letter replaced by the first target letter, and having the second source letter replaced by the second target letter.

The second section is structured in a manner so as to allow the user of the method to quickly understand that the first target letter represents the first source letter, and that the second target letter represents the second source letter. Thus, to the user, once it is understood that specific target letters represent specific source letters, the user can quickly and easily read terms with source letters replaced by target letters.

The second section further comprises a second application section following the at least one second supplemental sentence, wherein the second application section comprises a plurality of writings in the form of rhymes, poetry, short stories and other literary works, historical documents and the like, and including excerpts therefrom, comprised of prominent compositions. The writings each comprise a number of sentences which include source terms each having all occurrences of the first source letter thereof replaced by the first target letter, and all occurrences of the second source letter thereof replaced by the second target letter. The writings may comprise an excerpt and/or passage, and/or a complete writing or complete literary composition such as Casey At The Bat, by Ernest L. Thayer, wherein the source terms therein each having all occurrences of the first source letter thereof replaced by the first target letter, and all occurrences of the second source letter thereof replaced by the second target letter.

The second section includes a second unit section following the second application section, wherein second unit section comprises a vertical list of short phrases or sentences printed with source terms, denoted as column “A”, but having the first source letter and second source letter thereof replaced by the first target letter and second target letter, respectively. Adjacent to column “A”, an additional vertical list of short phrases or sentences is provided and denoted as column “B”, wherein the phrases are identical in number with respect to phrases or sentences imprinted in column “A” and are horizontally aligned therewith so as to form a corresponding number of rows of text. The short phrases provided in column “B” comprise the target language translations of the sentences provided in column “A”. The short phrases provided in column “B” are written so as to follow the syntax structure of the target language. More specifically, the phrases provided in each row under column “B” provide the translations which are written either from left to right or from right to left for each phrase in corresponding adjacent rows. Like column “B” in the first section, the use of column “B” in the second section introduces the user to the proper syntax structure and proper transmutative form concerning the target language.

The plurality of sections further comprises a plurality of supplemental sections comprised of target letters which are introduced incrementallywith respect to each successive supplemental section. More specifically, an additional, undisclosed target letter is introduced into each succeeding supplemental section in a progressive manner, whereby the total number of target letters increases incrementally within each successive supplemental section. Thus, the plurality of supplemental sections are written in a manner so as to correspond with the progressional pattern concerning the addition of target letters as described hereinabove with respect to the first section and the second section.

Like the first section and the second section, the supplemental sections each includes at least one replacement sentence having each occurrence of source letters therein replaced by their corresponding target letters.

In addition, the supplemental sections each comprises: at least one second supplemental sentence printed directly below the at least one replacement sentence; an application section following the at least one supplemental sentence; and a unit section following the application section. The at least one replacement sentence, the at least one second supplemental sentence, the application section, and the unit section comprising each of the supplemental sections comprise the progressive format as described in detail above with respect to the same provided in the first section and second section regarding the incremental addition of target letters to each succeeding section. More specifically, an additional, undisclosed target letter is introduced into each succeeding supplemental section in a progressive manner, whereby the total number of target letters increases incrementally within each successive supplemental section.

Upon completion of the supplemental sections, target language words in proper syntax structure are slowly substituted to replace words provided in the group which includes the at least one replacement sentences, the at least one second supplemental sentences, the application sections, and the unit sections comprising the reading book.

Once user is familiarized with target language words, target language words are grouped into meaningful word clusters in order to facilitate comprehension.

In order to motivate the student through apperception so as to facilitate greater success in learning a foreign language, motion picture videos with closed captioning are included. By appealing to a student's interest in particular movies or motion picture videos, implementation of the present invention becomes less arduous, thereby considerably enhancing the ability and probability of learning a desired foreign language. As the video plays, the audible speech or sounds of the video are silenced and text captions are concurrently displayed transcribing the silenced speech intermittently throughout the duration or length of the video. The text captions comprise at least one first replacement sentence, at least one second replacement sentence, and a plurality of supplemental sections which includes a plurality of auxiliary replacement sentences. The replacement sentences utilized in the text captions comprise target letters which are introduced incrementally with respect to each successive section of replacement sentences as the video progresses. The target letters replace corresponding source letters. More specifically, an additional, undisclosed target letter is introduced into each succeeding replacement sentence in a progressive manner, whereby the total number of target letters increases incrementally within each successive replacement sentence. Thus, the plurality of replacement sentences are written in a manner so as to correspond with the progressional pattern concerning the addition of target letters as described earlier above with respect to the at least one first replacement sentence and the at least one second replacement sentence.

The use of the present invention allows for a foreign language to be learned in a quick, easy, and efficient manner.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the learning aid, according to the preferred embodiment of the present invention;

FIG. 2 is a sample illustration of the first section of the learning aid showing sentences with source terms, first replacement sentences, and first supplemental sentences;

FIG. 3 is a sample illustration of the first section of the learning aid showing a plurality of first supplemental sentences;

FIG. 4 is a sample illustration of the first section of the learning aid showing the first application section thereof;

FIG. 5 is a sample illustration of the first section of the learning aid showing the first unit section thereof;

FIG. 6 is a sample illustration of the second section of the learning aid showing sentences with source terms, second replacement sentences, and second supplemental sentences;

FIG. 7 is a sample illustration of the second section of the learning aid showing the second application section thereof;

FIG. 8 is a sample illustration of the second section of the learning aid showing the second unit section thereof;

FIG. 9 is a sample illustration of a supplemental section of the learning aid showing a group of words being replaced with target language words which are in proper syntax structure; and

FIG. 10 is a sample illustration of the learning aid showing target language words grouped into meaningful word clusters; and

FIG. 11 is side elevational view of a motion picture video with closed captioning shown displayed on a television screen.

### DESCRIPTION OF THE PREFERRED EMBODIMENT

### 1. Detailed Description of the Figures

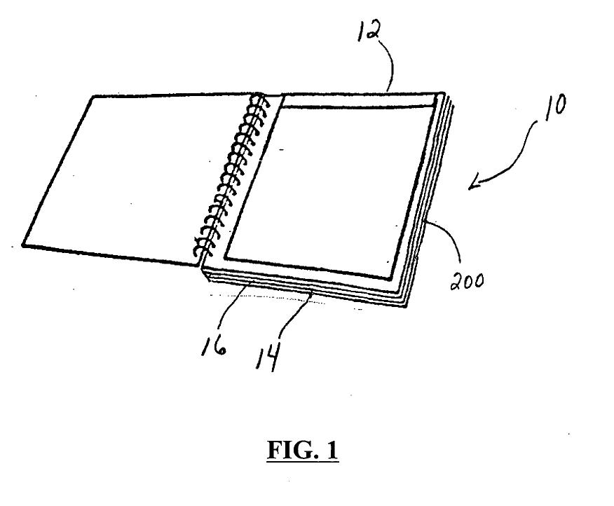

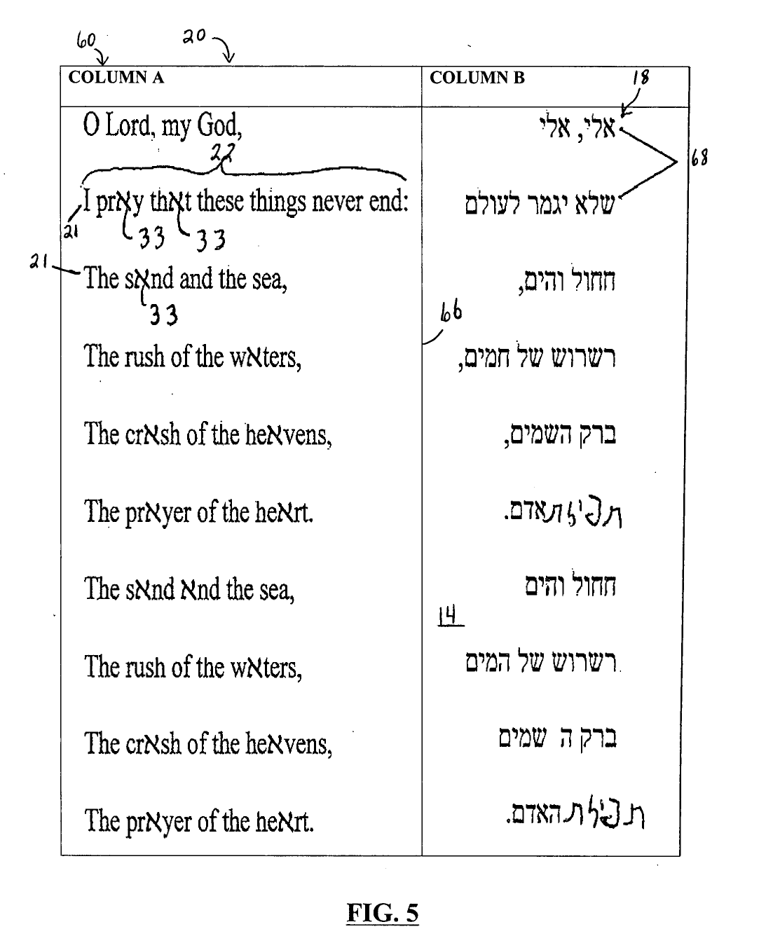

Referring now to FIGS. 1-10, a method for learning a foreign language using a learning aid 10 is disclosed and described in accordance with the present invention. The learning aid 10 comprises a reading book 12 or manual having a plurality of pages 14 or sheets organized into a plurality of sections 16 which are read in an orderly fashion in order to facilitate incremental advancement and masterfulness concerning the learning of a target language 18 or desired foreign language, which, in the example provided in FIG. 5, are Hebrew terms.

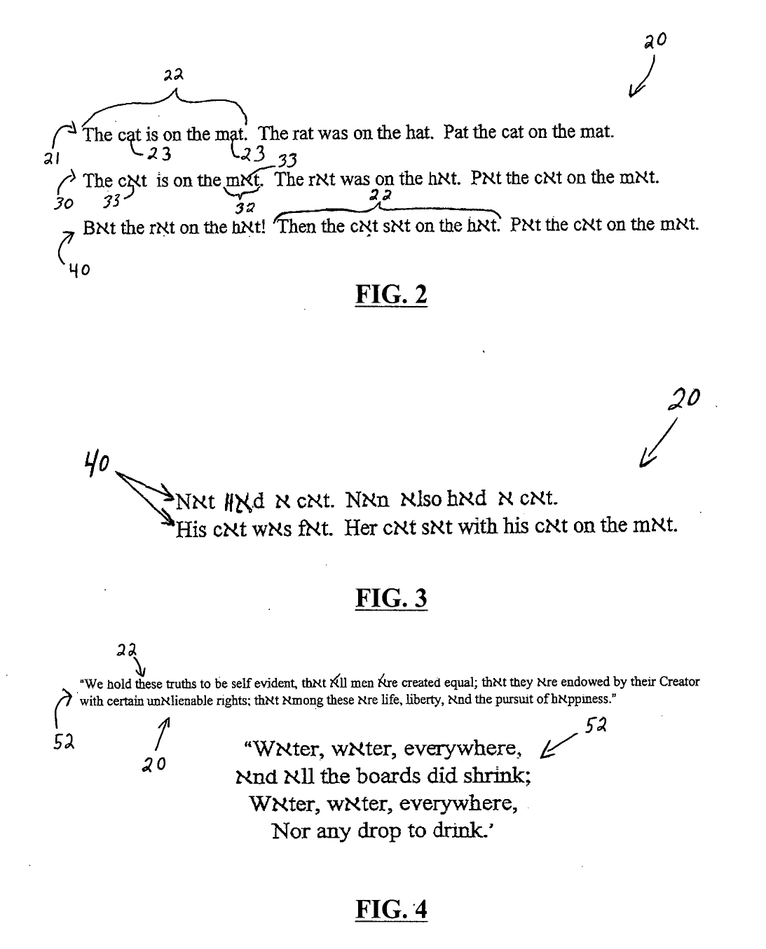

Referring more specifically to FIG. 2, the plurality of sections 16 comprises a first section 20 comprised of at least one sentence 21 printed with source terms 22. Source terms 22 are defined as individual terms printed in user's or student's native language and may include but are not limited to nouns, pronouns, adjectives, verbs, adverbs, pronouns, prepositions, and the like. The source terms 22 are comprised of source letters, symbols, scripts, and/or characters 23. The source terms 22 illustrated in FIG. are English terms. Below the at least one sentence 21 of source terms 22, at least one first replacement sentence 30 is provided. The replacement sentence 30 comprises the at least one sentence 21, shown printed directly thereabove, but having each occurrence of a specific single source letter 23, which appears in each term 22 of the at least one sentence 21, replaced by a first target letter 33. The first target letter 33 is a transliteration of the specific single source letter 23. To illustrate, examples provided in FIG. 2, namely, “The cat is on the mat.”, “The rat was on the hat.”, and “Pat the cat on the mat.” demonstrate the at least one sentence 21 printed with source terms 22. The at least one sentence 21 illustrated in FIG. 2 is shown as being three in number and adjacently aligned. Located directly below each of the at least one sentence 21, the first replacement sentences 30 illustrate that the letter “a” or source letter 23 in each term 32 thereof has been replaced by the first target letter 33, namely, “ [symbol] ”. In addition, the first replacement sentences 30 correspond in number and alignment with the number of the at least one sentence 21 printed directly thereabove. The first replacement sentences 30 are shown in FIG. 2 as being three in number.

The present invention allows the user/student to progress in the building of an active foreign language alphabet in a natural way as it is done in user's native language.

Printed directly below the first replacement sentence(s) 30, an at least one first supplemental sentence 40 is provided, wherein the at least one first supplemental sentence 40 comprises source terms 22 having the single source letter 23, namely “a” in this particular example, replaced by the first target letter 33, namely “ [symbol] ” also in this particular example. For purposes of illustration only, three at least one first supplemental sentences 40 are provided in FIG. 2, wherein the first thereof includes “B [symbol] t the r [symbol] t on the h [symbol] t!”.

The first section 20 is structured in a manner so as to allow the user of the method 10 to quickly understand that the first target letter 33 represents a specific source letter 23. Replacement of a specific source letter 23 with a specific target letter 33 as described in accordance with the aforementioned manner also facilitates instantaneous recall concerning the source letter 23/target letter 33 replacement relationship. To enhance this understanding, a plurality of first supplemental sentences 40 may be printed in the first section 20, wherein first supplemental sentences 40 are separate from each other and arranged adjacently and vertically, as shown by the examples provided in FIG. 3.

Referring now to FIG. 4, the first section 20 further comprises a first application section 50 following the at least one first supplemental sentences 40, wherein the application section 50 comprises a plurality of writings 52, in the form of rhymes, poetry, short stories and other literary works, historical documents and the like, and including excerpts therefrom, comprised of prominent compositions. The writings 52 each comprises a number of sentences which include source terms 22 each having all occurrences of the source letter 23 thereof replaced by the first target letter 33. The source letter 23 corresponds to the same source letter 23 as denoted heretofore in the first section 20, and the first target letter 33 corresponds to the same first target letter 33 denoted in the first section 20. FIG. 4 illustrates two writings 52. The uppermost writing 52 includes an excerpt from The Declaration of Independence, wherein the excerpt provides as follows: “We hold these truths to be self evident, th [symbol] t [symbol] ll men [symbol] re cre [symbol] ted equ [symbol] l; th [symbol] t they [symbol] re endowed by their Cre [symbol] tor with cert [symbol] in un [symbol] lienable rights; th [symbol] t [symbol] mong these [symbol] re life, liberty, [symbol] nd the pursuit of h [symbol] ppiness.”

The writing 52 provided directly hereinbelow includes a passage from The Rime of the Ancient Mariner, by Samuel Taylor Coleridge, wherein such passage provides as follows: “W [symbol] ter, w [symbol] ter, everywhere, [symbol] nd [symbol] ll the bo [symbol] rds did shrink; W [symbol] ter, w [symbol] ter, everywhere, Nor [symbol] ny drop to drink.” While the two writings 52 illustrate an excerpt and a passage respectively, the writings 52 may comprise a complete writing or complete literary composition such as Casey At The Bat, by Ernest L. Thayer, wherein the source terms 22 therein each having all occurrences of the source letter 23 thereof replaced by the first target letter 33.

Referring now to FIG. 5, the first section 20 includes a first unit section 60 following the first application section 50, wherein first unit section 60 comprises a vertical list of short phrases or sentences 21 printed with source terms 22, denoted as column “A”, but having the source letter 23 replaced by the first target letter 33. Adjacent to column “A”, an additional vertical list of short phrases or sentences 68 is provided and denoted as column “B”, wherein the phrases 68 are identical in number with respect to phrases or sentences 21 imprinted in column “A” and are horizontally aligned therewith so as to form a corresponding number of rows of text. The short phrases 68 provided in column “B” comprise the target language 18 translations of the sentences 21 provided in column “A”. The short phrases 68 provided in column “B” are written so as to follow the syntax structure of the target language 18. More specifically, the phrases 68 provided in each row under column “B” provide the translations which are written either from left to right or from right to left for each phrase 21 in corresponding adjacent rows. The determination as to whether each phrase 68 under column “B” is written left to right or right to left is dependent upon the natural, direction in which the target language 18 is written. The phrases 68 shown printed in column “B” comprise Hebrew text and are therefore written right to left. To further illustrate, the following phrase is provided in the first row under column “A” in FIG. 5: “O Lord, my God,”. The translation of this phrase 21 from the native language (herein shown as English for purposes of example only) to the target language 18 (herein shown as Hebrew for purposes of example only) following proper syntax structure is provided in column “B”, which provides in relevant part: [symbol] Column “A” and column “B” may be separated by an elongated vertical line 66 imprinted on the page 14 thereof. The use of column “B” introduces the user to the proper syntax structure and proper transmutative form concerning the target language 18. The transmutative form is the literal translation of the native language to the target language 18, and such form may be a contracted or an expanded writing in comparison to the language being translated, particularly where one language is character-based. For example, generally, text written in Hebrew is written without vowels.

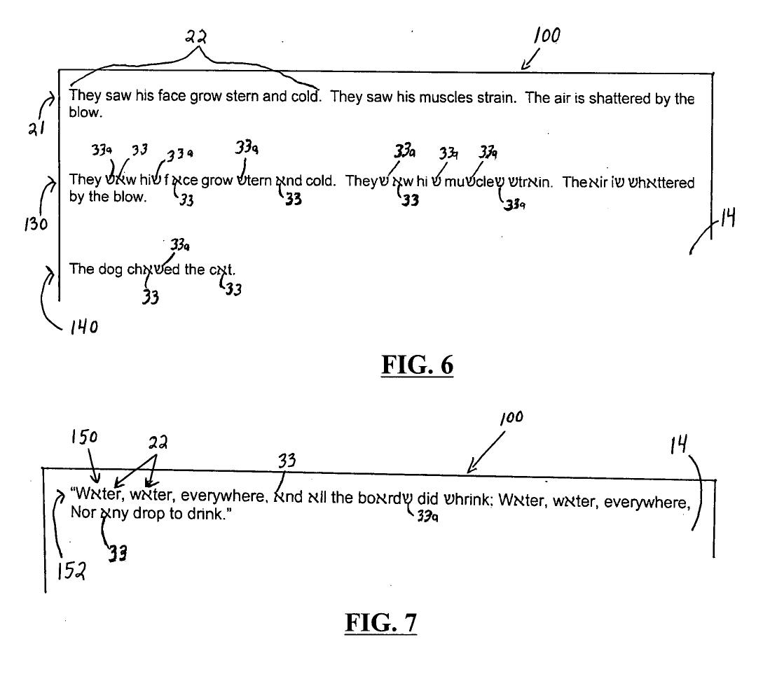

Referring now to FIGS. 6-8, the plurality of sections 16 includes a second section 100 following the first unit section 60. The second section 100 is comprised of at least one sentence 21 printed with source terms 22. Below the at least one sentence 21 of source terms 22, at least one second replacement sentence 130 is provided. The second replacement sentence 130 comprises the at least one sentence 21, shown printed directly thereabove, but having each occurrence of the first source letter 23 replaced by the first target letter 33 as described in the first section 20, and having each occurrence of a second source letter 23a replaced by a second target letter 33a. To illustrate, examples provided in FIG. 6, namely, “They saw his face grow stern and cold.”, “They saw his muscles strain.”, and “The air is shattered by the blow.” demonstrate the at least one sentence 21 printed with source terms 22. The at least one sentence 21 illustrated in FIG. 6 is shown as being three in number and adjacently aligned. Located directly below the at least one sentence 21, the second replacement sentences 130 illustrate that the letter “a” or first source letter 23 in each term 132 thereof has been replaced by the first target letter 33, namely, [symbol] , and the letter “s” or second source letter 23a in each term 132 thereof has been replaced by the second target letter 33a, namely, [symbol] The first target letter and the second target letter are transliterations of the first source letter and the second source letter, respectively. The second replacement sentences 130 correspond in number and alignment with the number of the at least one sentence 21 printed directly thereabove. The second replacement sentences 130 are shown in FIG. 6 as being three in number.

Printed directly below the second replacement sentence(s) 130, an at least one second supplemental sentence 140 is provided, wherein the at least one second supplemental sentence 140 comprises source terms 22 having the first source letter 23, namely “a” in this particular example, replaced by the first target letter 33, namely [symbol] , and having the second source letter 23a, namely “s” replaced by the second target letter 33a, namely [symbol] . For purposes of illustration, only one second supplemental sentence 140 is depicted in FIG. 6, which provides: “The dog ch [symbol] [symbol] ed the c [symbol] t.”

The second section 100 is structured in a manner so as to allow the user of the method 10 to quickly understand that the first target letter 33 represents the first source letter 23, and that the second target letter 33a represents the second source letter 23a. Thus, to the user, once it is understood that specific target letters 33, 33a represent specific source letters 23, 23a, the user can quickly and easily read terms with source letters 23, 23a replaced by target letters 33, 33a.

Referring now more specifically to FIG. 7, the second section 100 further comprises a second application section 150 following the at least one second supplemental sentence 140, wherein the second application section 150 comprises a plurality of writings 152 in the form of rhymes, poetry, short stories and other literary works, historical documents and the like, and including excerpts therefrom, comprised of prominent compositions. The writings 152 each comprise a number of sentences which include source terms 22 each having all occurrences of the first source letter 23 thereof replaced by the first target letter 33, and all occurrences of the second source letter 23a thereof replaced by the second target letter 33a. An example of the plurality of writings 152 is provided in FIG. 7, which includes a passage from The Rime of the ancient Mariner, wherein such passage provides as follows: “W [symbol] ter, w [symbol] ter, everywhere, [symbol] nd [symbol] ll the bo [symbol] rd [symbol] did [symbol] hrink; W [symbol] ter, w [symbol] ter, everywhere, Nor [symbol] ny drop to drink.”

The plurality of writings 152 are envisioned to comprise a complete writing or complete literary composition such as Casey At The Bat, wherein the source terms 22 therein each having all occurrences of the first source letter 23 and the second source letter 23a thereof replaced by the first target letter 33 and the second target letter 33a, respectively.

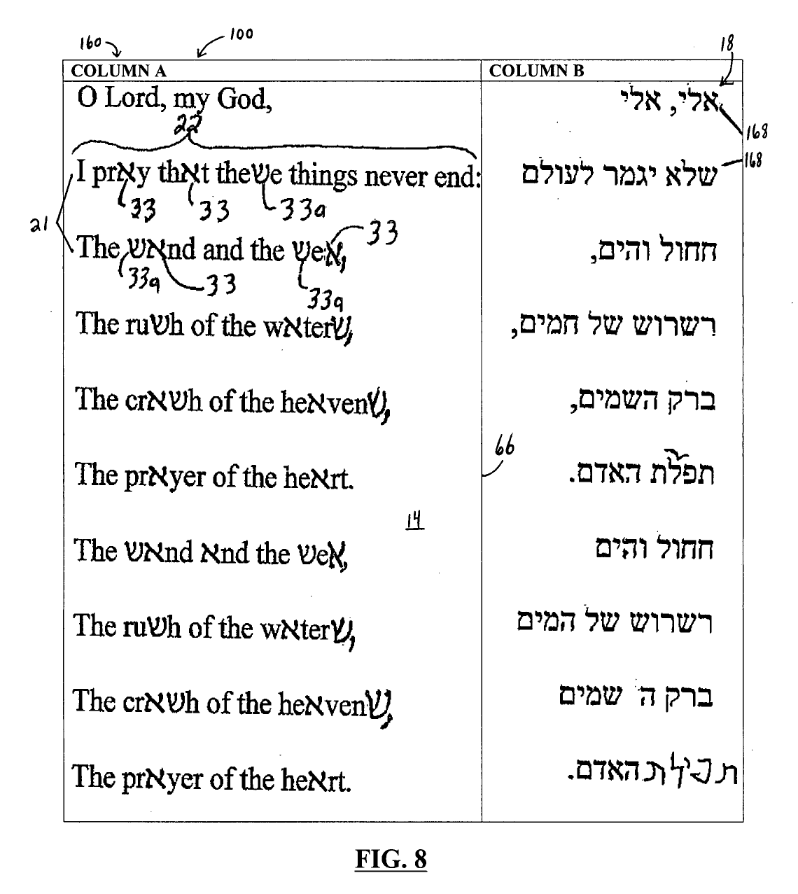

Referring now more specifically to FIG. 8, the second section 100 includes a second unit section 160 following the second application section 150, wherein second unit section 160 comprises a vertical list of short phrases or sentences 21 printed with source terms 22, denoted as column “A”, but having the first source letter 23 and second source letter 23a thereof replaced by the first target letter 33 and second target letter 33a, respectively. Adjacent to column “A”, an additional vertical list of short phrases or sentences 168 is provided and denoted as column “B”, wherein the phrases 168 are identical in number with respect to phrases or sentences 21 imprinted in column “A” and are horizontally aligned therewith so as to form a corresponding number of rows of text. The short phrases 168 provided in column “B” comprise the target language 18 translations of the sentences 21 provided in column “A”. The short phrases 168 provided in column “B” are written so as to follow the syntax structure of the target language 18. More specifically, the phrases 168 provided in each row under column “B” provide the translations which are written either from left to right or from right to left for each phrase 21 in corresponding adjacent rows. The determination as to whether each phrase 168 under column “B” is written left to right or right to left is dependent upon the natural direction in which the target language 18 is written. The phrases 168 shown printed in column “B” comprise Hebrew text and are therefore written right to left. To further illustrate, the following phrase is provided in FIG. 8, second row under column “A”: “I pr [symbol] y th [symbol] t the [symbol] e thing [symbol] never end:”. The translation of this phrase 21 from the native language (herein shown primarily as English for purposes of example only) to the target language 18 (herein shown as Hebrew for purposes of example only) following proper syntax structure is provided in column “B”, which provides in relevant part: [symbol] Column “A” and column “B” may be separated by an elongated vertical line 66 imprinted on the page 14 thereof. Like column “B” in the first section 20, the use of column “B” in the second section 100 introduces the user to the proper syntax structure and proper transmutative form concerning the target language 18.

The plurality of sections 16 further comprises a plurality of supplemental sections 200 comprised of target letters which are introduced incrementally with respect to each successive supplemental section. More specifically, an additional, undisclosed target letter is introduced into each succeeding supplemental section 200 in a progressive manner, whereby the total number of target letters increases incrementally within each successive supplemental section 200. Thus, the plurality of supplemental sections 200 are written in a manner so as to correspond with the progressional pattern concerning the addition of target letters as described hereinabove with respect to the first section 20 and the second section 70.

Like the first section 20 and the second section 70, the supplemental sections 200 each includes at least one replacement sentence having each occurrence of source letters therein replaced by their corresponding target letters.

In addition, the supplemental sections 200 each comprises: at least one supplemental sentence printed directly below the at least one replacement sentence; an application section following the at least one supplemental sentence; and a unit section following the application section. The at least one replacement sentence, the at least one supplemental sentence, the application section, and the unit section comprising each of the supplemental sections 200 comprise the progressive format as described in detail above with respect to the same provided in the first section 20 and second section 70 regarding the incremental addition of target letters to each succeeding section. More specifically, an additional, undisclosed target letter is introduced into each succeeding supplemental section 200 in a progressive manner, whereby the total number of target letters increases incrementally within each successive supplemental section 200.

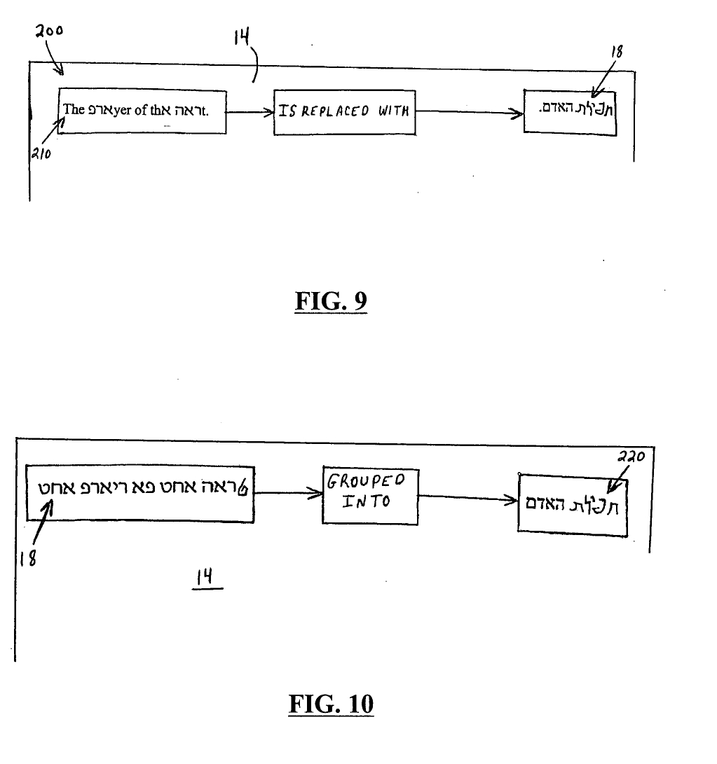

Upon completion of the supplemental sections 200, target language 18 words in proper syntax structure are slowly substituted to replace words 210, phrases, or sentences provided in the group which includes the at least one replacement sentences, the at least one supplemental sentences, the application sections, and the unit sections comprising the reading book 12. An example of such substitution is provided in FIG. 9.

Referring now to FIG. 10, once user is familiarized with target language 18 words, target language 18 words are grouped into meaningful word clusters 220 in order to facilitate comprehension.

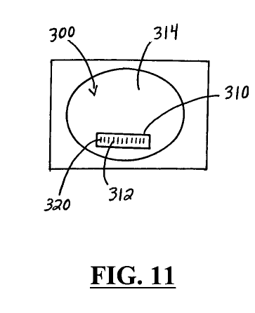

Finally, referring to FIG. 11, in order to motivate the student through apperception so as to facilitate greater success in learning a foreign language, motion picture videos 300 with closed captioning 310 are augmented. The motion picture videos 300 are envisioned to be available in various media, i.e., Digital Video Disc (DVD) and Video Home System (VHS). By appealing to a user's interest in particular movies or motion picture videos 300, implementation of the method 10 becomes less arduous, thereby considerably enhancing the ability and probability of learning a desired foreign language. Motion picture videos 300 with closed captioning 310 is envisioned to include movies such as “A Raison in the Sun”, “Spider-Man”, “Old Yeller”, and “The Old Man and the Sea”. As the video 300 plays, text captions 312 are displayed on atelevision screen 314 thattranscribe the audio portion, such as speech and often other relevant sounds of the video 300 in the manner as to be described hereinbelow.

In the course of video 300 play, the audible speech or sounds of the video 300 are silenced and text captions 312 are concurrently displayed transcribing the silenced speech intermittently throughout the duration or length of the video 300. For example, the speech or sounds of the video 300 may be silenced and text captions 312 displayed at ten minute intervals. The text captions 312 comprise at least one first replacement sentence 30, at least one second replacement sentence 130, and a plurality of supplemental sections 200 which includes a plurality of replacement sentences 320 according to the method 10 for learning a foreign language as described earlier above. The replacement sentences 320 comprise target letters introduced incrementally with respect to each successive supplemental section 200 as the video 300 progresses. The target letters replace corresponding source letters. More specifically, an additional, undisclosed target letter is introduced into each succeeding replacement sentence 320 in a progressive manner, whereby the total number of target letters increases incrementally within each successive replacement sentence 320. Thus, the plurality of replacement sentences 320 are written in a manner so as to correspond with the progressional pattern concerning the addition of target letters as described earlier above with respect to the at least one first replacement sentence 30 and the at least one second replacement sentence 130.

It is envisioned that the learning aid 10 may be available in the form of computer software developed for use according to the above described methods.

### 2. Operation of the Preferred Embodiment

To use the present invention, user reads the plurality of sections 16 in an orderly fashion as described in the specification in order to facilitate incremental or progressive advancement and masterfulness concerning the learning of a target language 18 or desired foreign language.

The use of the present invention allows for a foreign language to be learned in a quick, easy, and efficient manner.

Therefore, the foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be broadly limited only by the following Claims.

What is claimed is:

1. A learning aid for learning a foreign language, said learning aid comprising:
a reading book, said reading book having a plurality of pages organized into a plurality of sections, said plurality of sections are read in an orderly fashion in order to facilitate incremental advancement and masterfulness concerning learning a target language, said plurality of sections comprising:
a first section;
a second section; and
a plurality of supplemental sections.

2. The learning aid of claim 1, wherein said first section comprises:
at least one sentence printed with source terms, wherein said source terms are defined as individual terms printed in user's native language, said source terms comprise source letters, symbols, scripts, and/or characters;
at least one first replacement sentence, said at least one first replacement sentence is provided below said at least one sentence of said source terms, said at least one first replacement sentence comprises said at least one sentence having each occurrence of a specific single source letter appearing in each term of said at least one sentence replaced by a first target letter, wherein said first target letter is a transliteration of said specific single source letter, said at least one first replacement sentence corresponds in number and alignment with a number of said at least one sentence;
an at least one first supplemental sentence, said at least one first supplemental sentence is printed directly below said at least one first replacement sentence, wherein said at least one first supplemental sentence comprises said source terms having said single source letter replaced by said first target letter;
a first application section, said first application section follows said at least one first supplemental sentence, wherein said first application section comprises a plurality of writings comprised of prominent compositions, said plurality of writings is in the form of rhymes, poetry, short stories and other literary works, and historical documents including excerpts therefrom, said plurality of writings each comprises a number of sentences which include said source terms each having all occurrences of said source letter thereof replaced by said first target letter;
a first unit section, said first unit section follows said first application section, said first unit section comprises a first vertical list of short phrases or sentences printed with said source terms, said source terms having said source letter replaced by said first target letter, said first unit section further comprises a second vertical list of short phrases or sentences printed adjacent to said first vertical list, wherein said short phrases provided in said second vertical list are identical in number with respect to said short phrases or sentences printed in said first vertical list and said short phrases in said second vertical list are horizontally aligned with said short phrases printed in said first vertical list so as to form a corresponding number of rows of text, said short phrases printed in said second vertical list comprise target language translations of said short phrases printed in said first vertical list, said short phrases printed in said second vertical list are printed in a manner so as to follow a syntax structure of said target language, said short phrases printed in said second vertical list are adapted to introduce a user of the learning aid to a proper syntax structure and proper transmutative form concerning said target language.

3. The learning aid of claim 1, wherein said second section comprises:
at least one sentence printed with said source terms, wherein said source terms are defined as individual terms printed in user's native language, said source terms comprise source letters, symbols, scripts, and/or characters;
at least one second replacement sentence, said at least one second replacement sentence is provided below said at least one sentence of said source terms, said at least one second replacement sentence comprises said at least one sentence having each occurrence of said first source letter replaced by said first target letter and having each occurrence of a second source letter replaced by a second target letter, said first target letter and said second target letter are transliterations of said first source letter and said second source letter, respectively, said at least one second replacement sentence corresponds in number and alignment with a number of said at least one sentence of said source terms printed directly thereabove;
an at least one second supplemental sentence, said at least one second supplemental sentence is printed directly below said at least one second replacement sentence, said at least one second supplemental sentence comprises said source terms having said first source letter replaced by said first target letter, and having all occurrences of said second source letter replaced by said second target letter;
a second application section, said second application section follows said at least one second supplemental sentence, wherein said second application section comprises a plurality of writings comprised of prominent compositions, said plurality of writing is in the form of rhymes, poetry, short stories and other literary works, and historical documents including excerpts therefrom, said plurality of writings each comprises a number of sentences which include said source terms each having all occurrences of said first source letter replaced by said first target letter, and having all occurrences of said second source letter replaced by said second target letter;
a second unit section, said second unit section follows said second application section, said second unit section comprises a first vertical list of short phrases or sentences printed with said source terms, said source terms having said first source letter and said second source letter replaced by said first target letter and said second target letter, respectively, said second unit section further comprises a second vertical list of short phrases or sentences printed adjacent to said first vertical list, wherein said short phrases provided in said second vertical list are identical in number with respect to said short phrases printed in said first vertical list and said short phrases or sentences provided in said second vertical list are horizontally aligned with said short phrases printed in said first vertical list so as to form a corresponding number of rows of text, said short phrases printed in said second vertical list comprise target language translations of said short phrases printed in said first vertical list, said short phrases printed in said second vertical list are printed in a manner so as to follow a syntax structure of said target language, said short phrases printed in said second vertical list are adapted to introduce the user of the learning aid to the proper syntax structure and propertransmutative form concerning said target language.

4. The learning aid of claim 1, wherein said plurality of supplemental sections each comprises at least one, undisclosed target letter introduced incrementally with respect to each a successive supplemental section in a manner such that a total number of the target letters increases incrementally within each said successive supplemental section.

5. The learning aid of claim 4, wherein said plurality of supplemental sections each comprises:
at least one sentence printed with said source terms, wherein said source terms are defined as individual terms printed in user's native language, said source terms comprise source letters, symbols, scripts, and/or characters;
at least one replacement sentence having each occurrence of source letters replaced by corresponding target letters;
at least one supplemental sentence printed directly below said at least one replacement sentence;
an application section, said application section follows said at least one supplemental sentence; and
a unit section following said application section.

6. The learning aid of claim 5, wherein said at least one replacement sentence, said at least one second supplemental sentence, said application section, and said unit section are each introduced with an additional, undisclosed target letter in a progressive manner such that a total number of said target letters increases incrementally within each successive supplemental section of said plurality of supplemental sections.

7. The learning aid of claim 6, wherein said at least one replacement sentence, said at least one second supplemental sentence, said application section, and said unit section each comprises words which are replaced with target language words, wherein said target language words are provided in proper syntax structure.

8. The learning aid of claim 7, wherein said target language words are grouped into meaningful word clusters in order to facilitate comprehension.

9. The learning aid of claim 2, wherein said source terms include but are not limited to nouns, pronouns, adjectives, verbs, adverbs, pronouns, and prepositions.

10. A learning aid for learning a foreign language, said learning aid comprising:
a reading book, said reading book having a plurality of pages organized into a plurality of sections, said plurality of sections are read in an orderly fashion in order to facilitate incremental advancement and masterfulness concerning learning a target language, said plurality of sections comprising:
a first section;
a second section;
a plurality of supplemental sections; and
a plurality of motion picture videos with closed captioning, wherein said closed captioning provides a transcription of audio portions of a selected video, said transcription is displayed as text captions on a television screen.

11. The learning aid of claim 10, wherein said first section comprises:
at least one sentence printed with source terms, wherein said source terms are defined as individual terms printed in user's native language, said source terms comprise source letters, symbols, scripts, and/or characters;
at least one first replacement sentence, said at least one first replacement sentence is provided below said at least one sentence of said source terms, said at least one first replacement sentence comprises said at least one sentence having each occurrence of a specific single source letter appearing in each term of said at least one sentence replaced by a first target letter, wherein said first target letter is a transliteration of said specific single source letter, said at least one first replacement sentence corresponds in number and alignment with a number of said at least one sentence;
an at least one first supplemental sentence, said at least one first supplemental sentence is printed directly below said at least one first replacement sentence, wherein said at least one first supplemental sentence comprises said source terms having said single source letter replaced by said first target letter;
a first application section, said first application section follows said at least one first supplemental sentence, wherein said first application section comprises a plurality of writings comprised of prominent compositions, said plurality of writings is in the form of rhymes, poetry, short stories and other literary works, and historical documents including excerpts therefrom, said plurality of writings each comprises a number of sentences which include said source terms each having all occurrences of said source letter thereof replaced by said first target letter;
a first unit section, said first unit section follows said first application section, said first unit section comprises a first vertical list of short phrases or sentences printed with said source terms, said source terms having said source letter replaced by said first target letter, said first unit section further comprises a second vertical list of short phrases or sentences printed adjacent to said first vertical list, wherein said short phrases provided in said second vertical list are identical in number with respect to said short phrases or sentences printed in said first vertical list and said short phrases in said second vertical list are horizontally aligned with said short phrases printed in said first vertical list so as to form a corresponding number of rows of text, said short phrases printed in said second vertical list comprise target language translations of said short phrases printed in said first vertical list, said short phrases printed in said second vertical list are printed in a manner so as to follow a syntax structure of said target language, said short phrases printed in said second vertical list are adapted to introduce a user of the learning aid to a proper syntax structure and proper transmutative form concerning said target language.

12. The learning aid of claim 10, wherein said second section comprises:
at least one sentence printed with said source terms, wherein said source terms are defined as individual terms printed in user's native language, said source terms comprise source letters, symbols, scripts, and/or characters;
at least one second replacement sentence, said at least one second replacement sentence is provided below said at least one sentence of said source terms, said at least one second replacement sentence comprises said at least one sentence having each occurrence of said first source letter replaced by said first target letter and having each occurrence of a second source letter replaced by a second target letter, said first target letter and said second target letter are transliterations of said first source letter and said second source letter, respectively, said at least one second replacement sentence corresponds in number and alignment with a number of said at least one sentence of said source terms printed directly thereabove;
an at least one second supplemental sentence, said at least one second supplemental sentence is printed directly below said at least one second replacement sentence, said at least one second supplemental sentence comprises said source terms having said first source letter replaced by said first target letter, and having all occurrences of said second source letter replaced by said second target letter;
a second application section, said second application section follows said at least one second supplemental sentence, wherein said second application section comprises a plurality of writings comprised of prominent compositions, said plurality of writing is in the form of rhymes, poetry, short stories and other literary works, and historical documents including excerpts therefrom, said plurality of writings each comprises a number of sentences which include said source terms each having all occurrences of said first source letter replaced by said first target letter, and having all occurrences of said second source letter replaced by said second target letter;
a second unit section, said second unit section follows said second application section, said second unit section comprises a first vertical list of short phrases or sentences printed with said source terms, said source terms having said first source letter and said second source letter replaced by said first target letter and said second target letter, respectively, said second unit section further comprises a second vertical list of short phrases or sentences printed adjacent to said first vertical list, wherein said short phrases provided in said second vertical list are identical in number with respect to said short phrases printed in said first vertical list and said short phrases or sentences provided in said second vertical list are horizontally aligned with said short phrases printed in said first vertical list so as to form a corresponding number of rows of text, said short phrases printed in said second vertical list comprise target language translations of said short phrases printed in said first vertical list, said short phrases printed in said second vertical list are printed in a manner so as to follow a syntax structure of said target language, said short phrases printed in said second vertical list are adapted to introduce the user of the learning aid to the proper syntax structure and proper transmutative form concerning said target language.

13. The learning aid of claim 10, wherein said plurality of supplemental sections each comprises at least one, undisclosed target letter introduced incrementally with respect to each a successive supplemental section in a manner such that a total number of the target letters increases incrementally within each said successive supplemental section.

14. The learning aid of claim 13, wherein said plurality of supplemental sections each comprises:
at least one sentence printed with said source terms, wherein said source terms are defined as individual terms printed in user's native language, said source terms comprise source letters, symbols, scripts, and/or characters;
at least one replacement sentence having each occurrence of source letters replaced by corresponding target letters;
at least one supplemental sentence printed directly below said at least one replacement sentence;
an application section, said application section follows said at least one supplemental sentence; and
a unit section following said application section.

15. The learning aid of claim 14, wherein said at least one replacement sentence, said at least one second supplemental sentence, said application section, and said unit section are each introduced with an additional, undisclosed target letter in a progressive manner such that a total number of said target letters increases incrementally within each successive supplemental section of said plurality of supplemental sections.

16. The learning aid of claim 15, wherein said at least one replacement sentence, said at least one second supplemental sentence, said application section, and said unit section each comprises words which are replaced with target language words, wherein said target language words are provided in proper syntax structure.

17. The learning aid of claim 16, wherein said target language words are grouped into meaningful word clusters in order to facilitate comprehension.

18. The learning aid of claim 10, wherein said text captions comprise at least one first replacement sentence, at least one second replacement sentence, and a plurality of auxiliary replacement sentences, said auxiliary replacement sentences comprise target letters being introduced singularly as an additional, undisclosed target letter into each successive auxiliary replacement sentence in a progressive manner, whereby a total number of said target letters increases incrementally within each said successive replacement sentence.

19. The learning aid of claim 10, wherein said audio portions of said selected video are silenced and said text captions are concurrently displayed transcribing the silenced audio portions intermittently throughout the duration or length of said video.

20. A method for learning a foreign language using a learning aid of claim 1, said method comprising the steps of:
a. providing the learning aid, said learning aid is comprised of a reading book which includes a plurality of pages organized into a plurality of sections, said plurality of sections comprises a first section, a second section, and a plurality of supplemental sections;
b. instructing a student to develop an ability to build an active foreign language alphabet by reading said first section, said first section includes phrases, sentences, and compositions having each occurrence of a first source letter replaced by a first target letter, wherein said first target letter and is a transliteration of said first source letter;
c. instructing the student to utilize auditory discrimination, schematic thinking, and figural thinking to develop an ability to build and learn an active foreign language by reading said second section and said plurality of supplemental sections, said second section includes phrases, sentences, and compositions having each occurrence of said first source letter replaced by said first target letter and having each occurrence of a second source letter replaced by a second target letter, wherein said first target letter and said second target letter are transliterations of said first source letter and said second source letter, respectively, and wherein said plurality of supplemental sections includes phrases, sentences, and compositions having target letters introduced singularly as an additional, undisclosed target letter into said phrases, sentences, and compositions in a progressive manner, whereby a total number of said target letters increases incrementally within each successive supplemental section;
d. grouping target language words into meaningful word clusters in order to facilitate comprehension; and
e. motivating the student through apperception to develop the ability to build and learn the active foreign language by viewing a desired motion picture video with closed captioning, wherein said closed captioning provides a transcription of audio portions of said selected motion picture video, said transcription is displayed as text captions on a television screen, said audio portions of said selected video are silenced and said text captions are concurrently displayed transcribing said silenced audio portions intermittently throughout the duration or length of said video, said text captions comprise at least one first replacement sentence, at least one second replacement sentence, and a plurality of auxiliary replacement sentences, wherein said at least one first replacement sentence having each occurrence of a specific single source letter appearing in each term thereof replaced by a first target letter, wherein said first target letter is a transliteration of said specific single source letter, said at least one second replacement sentence having each occurrence of said first source letter replaced by said first target letter and having each occurrence of a second source letter replaced by a second target letter, said first target letter and said second target letter are transliterations of said first source letter and said second source letter, respectively, and wherein said auxiliary replacement sentences comprise target letters being introduced singularly as an additional, undisclosed target letter into each successive auxiliary replacement sentence in a progressive manner, whereby a total number of said target letters increases incrementally within each said successive replacement sentence.
